(19) United States
(12) Patent Application Publication
(10) Pub. No.: US 2025/0076532 A1
(43) Pub. Date: Mar. 6, 2025

(54) RF DETECTION

(71) Applicant: Imperium Technologies, Inc., Cedar Park, TX (US)

(72) Inventors: Gordon JUDD, Pleasant Hill, CA (US); Brad MEDFORD, Cedar Park, TX (US); James CURRAN, Alexandria, OH (US)

(73) Assignee: Imperium Technologies, Inc., Cedar Park, TX (US)

(21) Appl. No.: 18/821,378

(22) Filed: Aug. 30, 2024

Related U.S. Application Data
(60) Provisional application No. 63/580,230, filed on Sep. 1, 2023.

(51) Int. Cl. G01V 8/00; F16T 1/00

(52) U.S. Cl. CPC G01V 8/005; F16T 1/00

(57) ABSTRACT

A detection system may include a vessel configured to contain one or more substances, a transmitting antenna disposed within the vessel, a receiving antenna disposed within the vessel, and a control system. The control system may be configured to: transmit first radio-frequency (RF) energy into the vessel via the transmitting antenna; receive second RF energy from the vessel via the receiving antenna; and based on a comparison of the first RF energy and the second RF energy, determine a presence of a particular substance within the vessel.

### CROSS-REFERENCE TO RELATED APPLICATION

This application claims priority to U.S. Provisional Application Ser. No. 63/580,230, filed Sep. 1, 2023, which is incorporated by reference herein in its entirety. This application is also related to U.S. Pat. No. 11,713,847 entitled “STEAM TRAP” which is incorporated by reference herein in its entirety.

### TECHNICAL FIELD

The present disclosure relates in general to the detection of one or more analytes within a sample. The specific example of detection of liquid water (e.g., condensate water) within a steam trap is discussed in detail herein. One of ordinary skill in the art with the benefit of this disclosure will appreciate its applicability to other substances and other situations.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use. In addition, information handling systems may include a variety of hardware and software components that may be configured to process, store, and communicate information and may include one or more computer systems, data storage systems, and networking systems.

In the context of steam traps, it is useful to be able to detect the presence and/or the amount of liquid water within a vessel. For example, when more than a threshold amount of water is present, the steam trap may open a valve in response, allowing the condensate water to drain. In other embodiments, other suitable actions may be taken in response to a detection event. For example, a notification may be sent to a user, a visual or auditory alarm may be activated, etc. Existing steam traps typically use mechanical or electrical sensors to detect liquid water. These sensors may suffer from various drawbacks, however, and so the present disclosure teaches the use of radio frequency (RF) electromagnetic radiation to perform analysis and determine the presence and/or amount of an analyte such as liquid water. Different analytes have different RF conduction characteristics, and so embodiments allow for investigating the contents of a vessel such as a steam trap by transmitting RF energy into the vessel and measuring the resulting signals.

Other embodiments of this disclosure have applications far beyond the steam trap context. For example, the ability to detect the presence of specific substances is critical in numerous areas, such as commercial, agricultural, and industrial use cases. This disclosure describes methods for using RF energy transmission to determine the presence and/or amount of substances (e.g., liquids, solids, gases, and combinations thereof). In various embodiments, detectors may be configured for detection of water, steam, air, other gases, hydrocarbons, sand, grain, etc.

In general, embodiments may be used for any or all of the following non-limiting list of examples:
1. Detection of an analyte (e.g., liquid water in the steam trap example).
2. Detection of an amount of an analyte (e.g., a volume of liquid water or a height of a water column in the steam trap example).
3. Discrimination between two or more different analytes within a sample (e.g., liquid water vs. steam in the steam trap example) that differ in their RF conductivity characteristics.
4. Detection of contamination in an analyte.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with existing analyte detection methods may be reduced or eliminated.

In accordance with embodiments of the present disclosure, a detection system may include a vessel configured to contain one or more substances, a transmitting antenna disposed within the vessel, a receiving antenna disposed within the vessel, and a control system. The control system may be configured to: transmit first radio-frequency (RF) energy into the vessel via the transmitting antenna; receive second RF energy from the vessel via the receiving antenna; and based on a comparison of the first RF energy and the second RF energy, determine a presence of a particular substance within the vessel.

In accordance with these and other embodiments of the present disclosure, a method may include transmitting first radio-frequency (RF) energy into a vessel via one or more transmitting antennas; receiving second RF energy from the vessel via one or more receiving antennas; and based on a comparison of the first RF energy and the second RF energy, determining a presence of a particular substance within the vessel.

In accordance with these and other embodiments of the present disclosure, an article of manufacture may include a non-transitory, computer-readable medium having instructions coded thereon that are executable by a processor for: causing first radio-frequency (RF) energy to be transmitted into a vessel via one or more transmitting antennas; causing second RF energy to be received from the vessel via one or more receiving antennas; and comparing the first RF energy and the second RF energy to determine a presence of a particular substance within the vessel.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example detector, in accordance with embodiments of the present disclosure;

FIG. 3 illustrates an example RF modulation system, in accordance with embodiments of the present disclosure; and

FIG. 4 illustrates an example detector in a vessel having an obstruction, in accordance with embodiments of the present disclosure.

### DETAILED DESCRIPTION

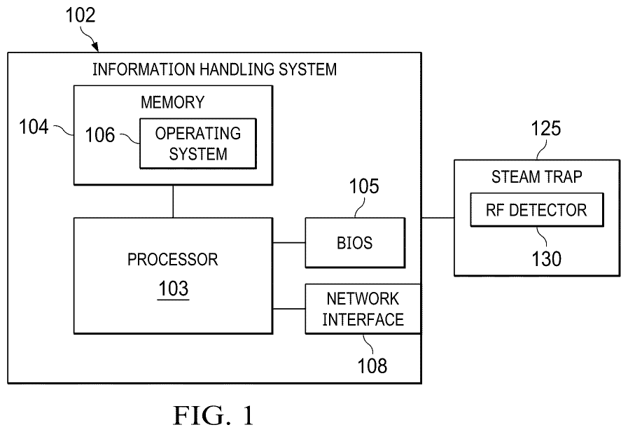

Preferred embodiments and their advantages are best understood by reference to FIGS. 1 through 4, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, microcontroller, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; and/or any combination of the foregoing.

FIG. 1 illustrates a block diagram of an example information handling system 102, in accordance with embodiments of the present disclosure. In some embodiments, information handling system 102 may comprise a server or a personal computer (e.g., a desktop computer, laptop computer, mobile computer, and/or notebook computer). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile and/or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Information handling system 102 may in some embodiments be communicatively coupled to steam trap 125 (or it may be a component thereof, or steam trap 125 may be a component of information handling system 102). As discussed above, steam traps 125 may be used to remove water from a steam system.

Steam trap 125 may include RF detector 130, which may be used to detect the presence and/or amount of liquid water within steam trap 125. RF detector 130 may include one or more antennas for transmitting and/or receiving RF signals, and it may be controlled by processor 103.

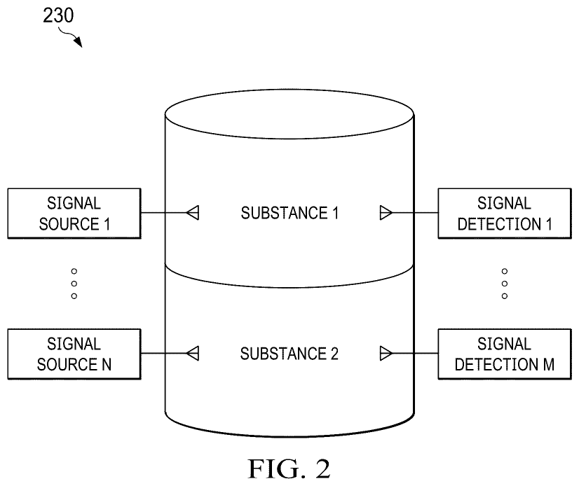

FIG. 2 provides an example view of an RF detector 230 in the context of a vessel in which two substances are present: substance 1 above, and substance 2 (e.g., a denser substance) below. One or more signal sources (also referred to as Tx-1 through Tx-n) may transmit RF energy into the vessel. The signal sources may direct the RF energy into the vessel via respective antennas (e.g., stainless steel antennas made of any suitable alloy) that penetrate into the interior of the vessel.

Likewise, one or more signal detectors (also referred to as Rx-1 through Rx-m, where n and m may be the same or different) may receive RF energy from the vessel. The signal detectors may also have antennas that penetrate into the vessel, and they may be the same or different in design as the transmitting antennas. Depending upon the presence and amount of particular substances within the vessel, the amount of RF power that is coupled between the signal source(s) and the signal detector(s) may change. In some embodiments, a phase shift may also be observed that varies depending on the presence and amount of particular substances.

RF detector 230 may include a control system (e.g., including a microcontroller) configured to manage the transmission and reception of RF energy.

For example, suppose substance 2 is associated with a higher RF transmissivity than substance 1. Then the signal sources and detectors that are disposed within substance 2 transmission efficiency than those will exhibit greater disposed within substance 1. By measuring the transmission characteristics between various pairs of signal sources and detectors, this embodiment may then be able to map out the locations within the vessel that contain substance 2, allowing an inference of the amount of substance 2 that is present. In other embodiments, reflection characteristics and/or absorption characteristics may also be used for these purposes.

That is, when substance 2 (e.g., water) is touching both the transmitting antenna and the receiving antenna, a change in amplitude may be seen, indicating the presence of substance 2. Likewise, when substance 2 no longer touches the one or both of the antennas, the amplitude will shift again. This level shift in the transmitted RF energy may be used as the primary detection criterion. Some substances may introduce a phase shift as well, discussed in more detail below with regard to Quadrature Modulation methods. This phase shift may also indicate the presence or absence of the substance for detection.

The various penetration points into the vessel for the antennas may be located in any suitable manner to address the design constraints in particular embodiments. The vessel is shown as a cylinder in this embodiment, but it may have any suitable shape in other embodiments. The vessel material may or may not be electrically coupled to the system or earth ground.

In one implementation, the vessel may be grounded, and the ground wires of the various antennas may be coupled to the same ground. The transmitting and receiving portions of each respective antenna may penetrate through the walls of the vessel and remain electrically isolated therefrom.

The transmitters Tx-1 through Tx-n may transmit RF energy in a continuous wave (CW) or as pulsed CW in some embodiments, or according to any desired modulation scheme. For example, Quadrature Amplitude Modulation (QAM), Orthogonal Frequency Division Multiplexing (OFDM), or other modulation schemes known to those skilled in the art may be used. The signals may or may not be modulated with additional information as well.

In some embodiments, only one signal source may be active at any given moment. For example, each transmitter may be activated in turn for a short period of time, and the transmitted RF energy may be measured at all of the detectors. In other embodiments, more than one signal source may be active simultaneously. For example, each transmitting antenna may include a corresponding modulation signal on top of the RF carrier, such that the receiving antennas are able to determine which signal source is associated with a given received signal. In one embodiment, OFDM may be used to allow multiple transmitting antennas and multiple receiving antennas all to be used simultaneously, with each transmitting antenna using a different frequency to probe for a different analyte.

The antenna configuration may be a conventional antenna or a non-typical shape to address particular application requirements.

The signal detector systems may be implemented with CW detection and/or with more complex signal-level sensing. These systems may also detect embedded modulation information in the transmitted signals, which may be used to determine which transmitting antenna was the source of a given portion of the detected RF energy.

Any suitable transmission power may be used (e.g,. from −80 dBm to +20 dBm in some embodiments). Further, any suitable frequency of RF energy may be used (e.g., from 50 kHz up to 20 GHz in some embodiments), and the choice of frequency may depend upon the particular analyte under test. For example, to determine a suitable frequency for a given analyte, a vessel may be tested at a range of frequencies both with and without the analyte present. Whichever frequency shows the largest difference in transmission efficiency (and/or phase shift) between the two scenarios may then be selected for use with that analyte. A control system may be programmed with data regarding various possible analytes and their associated suitable frequencies.

In the example of a steam trap, a frequency of 20 MHz has been found to give suitable results for distinguishing between steam and liquid water, with a transmission difference of 10 dB or more.

In general, the RF conductivity characteristics for two different substances will vary depending on their chemistry. If a substance were combined with some other substance, then its RF conductivity characteristics would differ. This difference would then indicate contamination of the substance. Accordingly, even if the identity and chemistry of the contaminant is unknown, that RF transmission shift may indicate contamination and may also indicate the level of contamination based on the amount of the shift.

Some substances may have a non-linear or chaotic RF response under particular conditions. For example, when a valve is opened to drain condensate, the condensate may partially flash into steam. As another example, a substance may have dissolved gas that bubbles out of solution in some these situations. In each of conditions, the RF characteristics may change, but the level of the substance may not. Accordingly, numerical techniques, statistics, learned behavior, known phenomena, and empirical knowledge may be used to inform the behavior of the detection system. These methods may need to be employed to accurately determine the difference between the two substances.

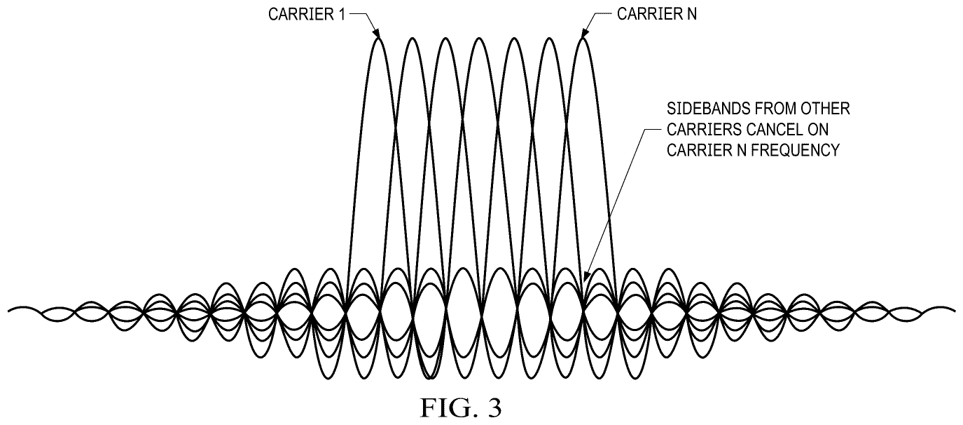

As noted above, an OFDM modulation scheme may be used in some embodiments. FIG. 3 illustrates an example of OFDM modulation using a plurality of carrier frequencies. Multiple carriers are separated in a manner that allows each carrier to be detected in both amplitude and any associated data used to modulate the signal. Each of the carriers may be arranged in any pattern, allowing the detection of the substances under study and/or for efficient data transfer.

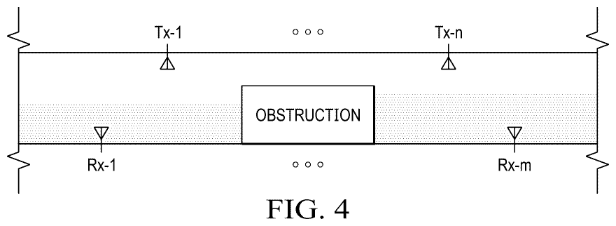

In some embodiments, a vessel may have an obstruction therein (e.g., a bend in a steam pipe, a piece of equipment, etc.) that may affect the transmission of RF energy. FIG. 4 illustrates one such embodiment.

As shown, the detection system in FIG. 4 allows the detection of substance levels in close proximity to each other. Tx-1 through Tx-n represent two or more transmitting systems. Likewise, Rx-1 through Rx-m represent two or more receiving systems. The transmitted signal from (for example) Tx-1 may be received by any of the m receivers, and the transmitted signal from any of the n transmitters may be received by (for example) Rx-1. Each receiving system may be configured to listen only to the particular carrier frequency associated with the transmitting antenna(s) that it can receive signals from in some embodiments. This enables the antenna on each side of the obstruction to determine the level of the analyte in question.

Some embodiments of this disclosure may be deployed within fixed infrastructure that is not served by wired or wireless networks. Accordingly, a data signal may modulated onto the transmitted signal. As the carrier signal is propagated through the vessel (which may include lengths of piping), it may be received and decoded by other devices similarly attached which are receiving the RF signal and which can decode the included data. This data may be embedded into a new transmission, at a different frequency, and received by other devices. Any receiving device may serve as a gateway to network topologies, thus linking the transmitting device with distant network hosts.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Unless otherwise specifically noted, articles depicted in the drawings are not necessarily drawn to scale. However, in some embodiments, articles depicted in the drawings may be to scale.

Further, reciting in the appended claims that a structure is “configured to” or “operable to” perform one or more tasks is expressly intended not to invoke 35 U.S.C. § 112 (f) for that claim element. Accordingly, none of the claims in this application as filed are intended to be interpreted as having means-plus-function elements. Should Applicant wish to invoke § 112 (f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. A detection system comprising:
a vessel configured to contain one or more substances;
a transmitting antenna disposed within the vessel;
a receiving antenna disposed within the vessel; and
a control system comprising a hardware processor and configured to:
transmit first radio-frequency (RF) energy into the vessel via the transmitting antenna;
receive second RF energy from the vessel via the receiving antenna; and
based on a comparison of the first RF energy and the second RF energy, determine a presence of a particular substance within the vessel.

2. The detection system of claim 1, wherein the transmitting antenna comprises a plurality of transmitting antennas.

3. The detection system of claim 1, wherein the receiving antenna comprises a plurality of receiving antennas.

4. The detection system of claim 1, wherein the comparison includes determining an amount of energy attenuation associated with the one or more substances.

5. The detection system of claim 1, wherein the comparison includes determining a phase shift associated with the one or more substances.

6. The detection system of claim 1, wherein the transmitting antenna and the receiving antenna comprise stainless steel.

7. The detection system of claim 1, wherein the vessel comprises a steam trap.

8. The detection system of claim 7, wherein the particular substance comprises liquid water.

9. The detection system of claim 8, wherein the control system is further configured to open a valve of the steam trap in response to the presence of the liquid water.

10. The detection system of claim 1, wherein the control system includes a non-transitory data storage medium.

11. The detection system of claim 10, wherein the non-transitory data storage medium includes a data structure indicating suitable RF frequencies for each of a plurality of substances.

12. The detection system of claim 1, wherein the first RF energy is transmitted as a continuous wave (CW).

13. The detection system of claim 1, wherein the first RF energy is transmitted as a modulated carrier wave.

14. The detection system of claim 13, wherein the modulated carrier wave is modulated according to an orthogonal frequency division multiplexing (OFDM) modulation.

15. The detection system of claim 1, wherein the control system is configured to transmit a notification to a user based on the presence of the particular substance.

16. A method comprising:
transmitting first radio-frequency (RF) energy into a vessel via one or more transmitting antennas;
receiving second RF energy from the vessel via one or more receiving antennas; and
based on a comparison of the first RF energy and the second RF energy, determining a presence of a particular substance within the vessel.

17. An article of manufacture comprising a non-transitory, computer-readable medium having instructions coded thereon that are executable by a processor for:
causing first radio-frequency (RF) energy to be transmitted into a vessel via one or more transmitting antennas;
causing second RF energy to be received from the vessel via one or more receiving antennas; and
comparing the first RF energy and the second RF energy to determine a presence of a particular substance within the vessel.
